(19) United States
(12) Patent Application Publication
(10) Pub. No.: US 2015/0376365 A1
(43) Pub. Date: Dec. 31, 2015

(54) POROUS MEMBRANES MADE OF CROSS-LINKED THERMOPLASTIC SILICONE ELASTOMER

(71) Applicant: WACKER CHEMIE AG, München (DE)

(72) Inventor: Tobias HALBACH, Muenchen (DE)

(21) Appl. No.: 14/766,823

(22) PCT Filed: Feb. 21, 2014
(86) PCT No.: PCT/EP2014/053452

§ 371 Date: Aug. 10, 2015

(30) Foreign Application Priority Data
Feb. 26, 2013 (DE) 10 2013 203 127.0

(51) Int. Cl. C08J 9/28; B01D 71/70; B01D 67/00

(52) U.S. Cl. CPC C08J 9/28; B01D 67/0006; B01D 71/70; C08J 2383/07

(57) ABSTRACT

The invention relates to a method for producing thin, porous membranes made of a thermoplastic silicone compound S, in which, in a first step, a solution or suspension of a silicone composition SZ, which contains the thermoplastic silicone elastomer S1 with alkenyl groups—and contains crosslinker V, is formed in a mixture of solvent L1 and solvent L2, in a second step, the solution or suspension is brought into a mold, in a third step, solvent L1 is removed from the solution or suspension until the solubility of the silicone composition SZ in the mixture of solvent L1 and solvent L2 falls below a threshold, wherein a phase A, which is rich in the silicone composition SZ,—and a phase B, which is poor in silicone composition SZ, are formed and thus the structural formation is carried out by phase A. In a fourth step, the solvent L2 and residues of solvent L1 are removed and the silicone composition SZ is subjected to a cross-linking, wherein the silicone compound S is formed. The invention also relates to the membranes of silicone compound S produced according to the method and their use for the separation of mixtures, in wound patches, for the coating of housings, building materials, as a layer in textiles or as packaging materials.

The invention relates to a process for producing crosslinked porous membranes comprising thermoplastic silicone elastomer, and also to the membranes obtainable thereby and to their use.

Membranes are thin porous moldings and are used to separate mixtures. They are further used in the textile sector, for example as breathable and water-repellent membrane. One advantage of membrane separation processes is that they can be carried out even at low temperatures, such as room temperature for example, and therefore have lower energy requirements compared with thermal separation processes, such as distillation.

Phase inversion by evaporation is a known way to process cellulose acetate or polyvinylidene fluoride into thin porous membranes. It does not need a coagulation medium or an additional foaming reaction. In the simplest case, a ternary mixture is prepared from a polymer, a volatile solvent and a second, less volatile solvent. Following wet film formation, the volatile solvent evaporates, causing the polymer to precipitate in the second solvent and form a porous structure. The pores are full of the second solvent. The second solvent is subsequently removed from the membrane, for example by washing or evaporation, to ultimately obtain a porous membrane. EP363364 for example describes the production of porous PVDF membranes on the basis of this process.

The use of this process for silicones is unfamiliar to a person skilled in the art, since any pores actually formed in the course of evaporation normally collapse again owing to the silicone still being flowable, and hence the membrane loses its porosity.

The production of porous silicone membranes by the Loeb-Sourirajan process is known. JP 59225703 for instance teaches the production of a porous silicone membrane comprising a silicone-carbonate copolymer. This process exclusively provides an anisotropic pore size along the film layer thickness. In addition, a separate coagulation bath is also required at all times.

DE102010001482 teaches the production of isotropic silicone membranes by evaporation-induced phase separation. This process is disadvantageous, however, in that this operation requires thermoplastic silicone elastomers, which renders the membranes thus obtainable distinctly less temperature-resistant than comparable thin foils of silicone rubber. Thermoplastic silicone elastomers further exhibit an undesired so-called “cold flow”, as a result of which the membrane structure of the porous membranes changes under sustained load.

The problem addressed by the present invention was therefore that of developing a process with which thin, porous, crosslinked and thermally stable silicone membranes are obtainable in a technically very simple manner, yet which no longer has the disadvantages of prior art production processes and membranes and which makes it possible to use thermoplastic silicone elastomers and is simple and economical to carry out.

The invention provides a process for producing thin porous membranes comprising thermoplastic silicone compound S, wherein a first step comprises forming a solution or suspension from silicone composition SZ which contains alkenyl-containing thermoplastic silicone elastomer S1, and crosslinker V, in a mixture of solvent L1 and solvent L2,

a second step comprises introducing the solution or suspension into a mold,
a third step comprises removing solvent L1 from the solution or suspension until the solubility of silicone composition SZ in the mixture of solvent L1 and solvent L2 is forfeited to form a phase A, which is rich in silicone composition SZ, and a phase B, which is lean in silicone composition SZ and hence to effect structure formation by said phase A, and
a fourth step comprises removing said solvent L2 and residues of solvent L1, and subjecting the silicone composition SZ to a crosslinking reaction to form silicone compound S. It was surprisingly found that this is a simple way of obtaining thin and crosslinked porous silicone membranes which are thermally stable and do not exhibit any “cold flow”.

Preferably, silicone composition SZ gels/coagulates in the third step and the thin porous membrane is obtained from phase A in the process. The pores are formed by phase B.

The silicone composition SZ may contain, as further components, catalyst K, alkenyl-containing silicone compound S2, and/or additive A.

Preferably used as thermoplastic silicone elastomer S1 are alkenyl-containing silicone copolymers. Examples of silicone copolymers of this type include the groups of silicone-carbonate, silicone-imide, silicone-imidazole, silicone-urethane, silicone-amide, silicone-polysulphone, silicone-polyethersulphone, silicone-polyurea and also silicone-polyoxalyldiamine copolymers.

Silicone elastomers S1 are covalently crosslinked with crosslinker V in the fourth step. When an alkenyl-containing silicone compound S2 is used in addition, it is likewise covalently crosslinked with silicone compound S1 by crosslinker V.

It is particularly preferable to use organopolysiloxane/polyurea/polyurethane/polyamide or polyoxalyldiamine copolymers of general formula (I)

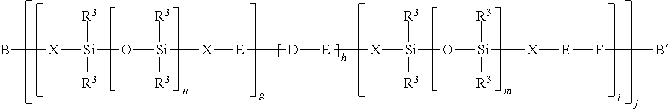

where structural element E is selected from the general formulae (Ia-f)

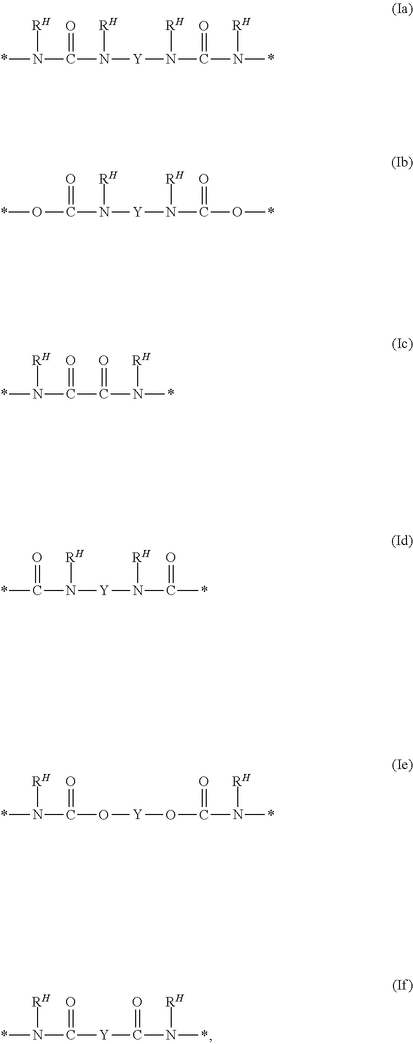

where structural element F is selected from the general formulae (IIa-f)

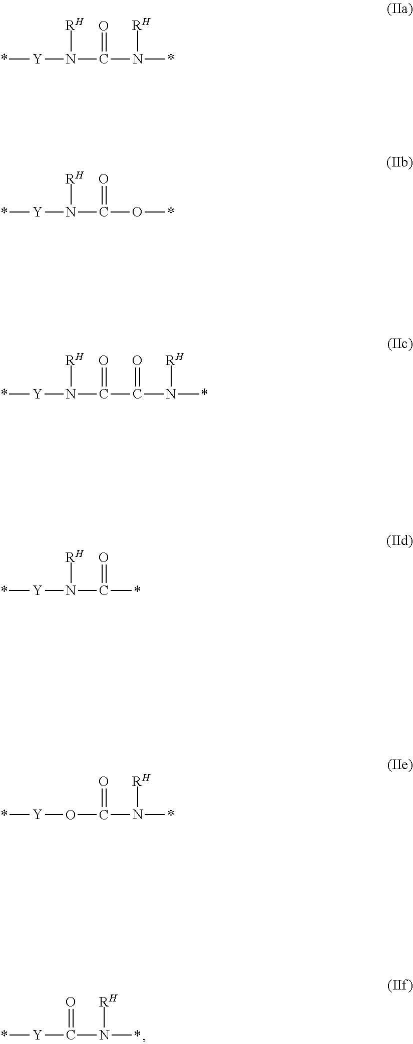

where
R³ represents substituted or unsubstituted hydrocarbon radicals which may be interrupted by oxygen or nitrogen atoms,
R^{H} represents hydrogen or has the meanings of R³,
X represents an alkylene radical of 1 to 20 carbon atoms where mutually non-adjacent methylene units may be replaced by —O— groups, or an arylene radical of 6 to 22 carbon atoms,
Y represents a divalent optionally fluorine- or chlorine-substituted hydrocarbon radical of 1 to 20 carbon atoms,
D represents an alkylene radical of 1 to 700 carbon atoms which is optionally substituted by fluorine, chlorine, C₁-C₆ alkyl or C₁-C₆ alkyl ester and in which mutually non-adjacent methylene units may be replaced by —O—, —COO—, —OCO—, or —OCOO— groups, or an arylene radical of 6 to 22 carbon atoms,
B and B′ each represent a reactive or non-reactive end group attached to the polymer by a covalent bond,
m represents an integer from 1 to 4000,
n represents an integer from 1 to 4000,
g represents an integer of not less than 1,
h represents an integer from 0 to 40,
i represents an integer from 0 to 30, and
j represents an integer above 0,
   with the proviso that at least two R³ radicals per molecule contain at least one alkenyl group.

R³ preferably represents monovalent hydrocarbon radicals of 1 to 18 carbon atoms which are optionally substituted with halogen atoms, amino groups, ether groups, ester groups, epoxy groups, mercapto groups, cyano groups or (poly)glycol radicals, the latter being constructed of oxyethylene and/or oxypropylene units, and more preferably represents alkyl radicals of 1 to 12 carbon atoms, especially methyl.

It is preferable for at least one R³ radical per siloxane unit

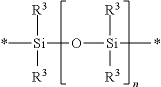

of the organopolysiloxane copolymers of general formula I to contain an alkenyl group, and very particularly preferable for 1-5 R³ radicals per siloxane unit

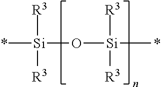

of the organopolysiloxane copolymers of general formula I to contain an alkenyl group.

Examples of R³ are alkyl radicals, such as methyl, ethyl, n-propyl, isopropyl, 1-n-butyl, 2-n-butyl, isobutyl, tert-butyl, n-pentyl, isopentyl, neopentyl, tert-pentyl; hexyl, such as n-hexyl; heptyl, such as n-heptyl; octyl, such as n-octyl and isooctyl, such as 2,2,4-trimethylpentyl; nonyl, such as n-nonyl; decyl, such as n-decyl; dodecyl, such as n-dodecyl; octadecyl, such as n-octadecyl; cycloalkyl, such as cyclopentyl, cyclohexyl, cycloheptyl and methylcyclohexyl; aryl, such as phenyl, naphthyl, anthryl and phenanthryl; alkaryl, such as o-, m-, p-tolyl; xylyl and ethylphenyl; and aralkyl, such as benzyl, alpha-phenylethyl and 3-phenylethyl.

Examples of substituted R³ are methoxyethyl, ethoxyethyl, ethoxyethoxyethyl, chloropropyl and trifluoropropyl.

Examples of divalent R³ are ethylene, polyisobutylenediyl and propanediyl-terminated polypropylene glycol radicals.

Examples of R³ radicals containing alkenyl groups are alkenyl radicals having 2 to 12, preferably 2 to 8 carbon atoms. Vinyl and n-hexenyl are preferred.

Preferably R^{H} represents hydrogen or the radicals noted above for R³.

Y is preferably a hydrocarbon radical of 3 to 13 carbon atoms which is optionally substituted with halogen atoms, such as fluorine or chlorine, more preferably a hydrocarbon radical of 3 to 13 carbon atoms, especially 1,6-hexamethylene, 1,4-cyclohexylene, methylenebis(4-cyclohexylene), 3-methylene-3,5,5-trimethylcyclohexylene, phenylene, naphthylene, m-tetramethylxylylene or methylenebis(4-phenylene).

Examples of divalent hydrocarbon radicals Y are alkylene radicals, such as methylene, ethylene, n-propylene, isopropylene, n-butylene, isobutylene, tert-butylene, n-pentylene, isopentylene, neopentylene, tert-pentylene, hexylene, such as n-hexylene, heptylene, such as n-heptylene, octylene, such as n-octylene and isooctylene, such as 2,2,4-trimethylpentylene, nonylene, such as n-nonylene, decylene, such as n-decylene, dodecylene, such as n-dodecylene; cycloalkylene radicals, such as cyclopentylene, cyclohexylene, cycloheptylene and methylcyclohexylene, such as methylenebis-(4-cyclohexylene) and 3-methylene-3,5,5-trimethylcyclohexylene; arylene radicals, such as phenylene and naphthylene; alkarylene, such as o-, m-, p-tolylene, xylylene, such as m-tetramethylxylylene, and ethylphenylene; aralkylene, such as benzylene, α-phenylethylene, β-phenylethylene and methylenebis(4-phenylene).

X is preferably an alkylene radical of 1 to 20 carbon atoms which may be interrupted by oxygen atoms, more preferably an alkylene radical of 1 to 10 carbon atoms which may be interrupted by oxygen atoms, even more preferably n-propylene, isobutylene, 2-oxabutylene or methylene.

Examples of X radicals are the examples denoted for Y and also optionally substituted alkylene radicals in which the carbon chain may be interrupted by oxygen atoms, for example 2-oxabutylene.

B is preferably a hydrogen atom, an OCN—Y—NH—CO— radical, an H₂N—Y—NH—CO— radical, an R³₃Si—(O—SiR³₂)ₙ— radical or an R³₃Si—(O—SiR³₂)ₙ—X-E- radical.

B′ preferably concerns the radicals noted for B.

D is preferably a divalent polyether or alkylene radical, more preferably a divalent polypropylene glycol radical or alkylene having at least 2 and at most 20 carbon atoms, such as ethylene, 2-methylpentylene or butylene, and especially is a polypropylene glycol radical of 2 to 600 carbon atoms, ethylene or 2-methylpentylene.

n is preferably a number of at least 3, especially at least 10 and preferably at most 800, especially at most 400.

m preferably denotes the ranges noted for n.

g is preferably a number of at most 100 and more preferably from 10 to 60.

h is preferably a number of at most 10, more preferably of 0 or 1, especially 0.

j is preferably a number of at most 400, more preferably 1 to 100, especially 1 to 20.

i is preferably a number of at most 10, more preferably of 0 or 1, especially 0.

An example is E=Ia, R^{H}=H, Y=75 mol % m-tetramethylxylylene and mol % methylenebis(4-cyclohexylene), R³=CH₃ and one H₂C═CH group per siloxane unit, X=n-propylene, D=2-methylpentylene, B,B′=H₂N—Y—NH—CO—, n=14, g=9, h=1, i=0, j=10.

Crosslinkers V can be for example SiH organosilicon compounds having at least two SiH functions per molecule, photoinitiators, photosensitizers, peroxides or azo compounds.

Organosilicon compounds containing two or more SiH functions per molecule can be used as crosslinkers V. The SiH-organosilicon compound preferably has a composition of average general formula (III)

H_{f}R⁵_{g}SiO_{(4-f-g)/2} (III),

where
R⁵ represents a monovalent, optionally halogen- or cyano-substituted C₁-C₁₈ hydrocarbon radical which is free of aliphatic carbon-carbon multiple bonds and is attached via SiC, and
f and g are non-negative integers,
   with the proviso that 0.5<(f+g)<3.0 and 0<f<2, and that each molecule contains at least two silicon-attached hydrogen atoms.

Examples of R⁵ are the radicals indicated for R². R⁵ preferably has from 1 to 6 carbon atoms. Methyl and phenyl are particularly preferred.

Use of an SiH-organosilicon compound which contains three or more SiH bonds per molecule is preferred. When an SiH-organosilicon compound having just two SiH bonds per molecule is used, it is advisable to use a thermoplastic silicone elastomer S1 and/or an alkenyl-containing silicone compound S2 which has three or more alkenyl groups per molecule.

The hydrogen content of the SiH-organosilicon compound, based exclusively on the hydrogen atoms directly attached to silicon atoms, is preferably in the range from 0.002% to 1.7% by weight of hydrogen, preferably in the range from 0.1% to 1.7% by weight of hydrogen.

The SiH-organosilicon compound preferably contains at least three and at most 600 silicon atoms per molecule. Use of an SiH-organosilicon compound containing from 4 to 200 silicon atoms per molecule is preferred.

The structure of the SiH-organosilicon compound can be linear, branched, cyclic or network-like.

Particularly preferred SiH-organosilicon compounds are linear polyorganosiloxanes of general formula (IV)

(HR⁶₂SiO_{1/2})ₛ(R⁶₃SiO_{1/2})ₜ(HR⁶SiO_{2/2})ᵤ(R⁶₂SiO_{2/2})ᵥ (IV),

where
R⁶ has the meanings of R⁵, and
the non-negative integers s, t, u and v satisfy the following relations: (s+t)=2, (s+u)>2, 5<(u+v)<200 and 1<u/(u+v)<0.1.

An example is R⁶=CH₃, t=2, u=48, v=90 or R⁶=CH₃, t=2, u=9, v=6 or R⁶=CH₃, s=2, v=11.

The SiH-functional SiH-organosilicon compound is preferably present in silicone composition SZ in such an amount that the molar ratio of SiH groups to alkenyl groups lies in the range from 0.5 to 5 and especially in the range from 1.0 to 3.0.

Photoinitiators and photosensitizers can also be used as crosslinkers V. Suitable photoinitiators and photosensitizers are respectively optionally substituted acetophenones, propiophenones, benzophenones, anthraquinones, benzils, carbazoles, xanthones, thioxanthones, fluorenes, fluorenones, benzoins, naphthalenesulphonic acids, benzaldehydes and cinnamic acids, and also mixtures of photoinitiators or photosensitizers.

Examples thereof are fluorenone, fluorene, carbazole; anisoin; acetophenone; substituted acetophenones, such as 3-methylacetophenone, 2,2′-dimethoxy-2-phenylacetophenone, 2,2-diethoxyacetophenone, 4-methylacetophenone, 3-bromoaceto-phenone, 3′-hydroxyacetophenone, 4′-hydroxyacetophenone, 4-allylacetophenone, 4′-ethoxyacetophenone, 4′-phenoxyaceto-phenone, p-diacetylbenzene, p-tert-butyltrichloroacetophenone; propiophenone; substituted propiophenones, such as 1-[4-(methylthio)phenyl]-2-morpholinepropanone, 2-hydroxy-2-methyl-propiophenone; benzophenone; substituted benzophenones, such as Michler's ketone, 3-methoxybenzophenone, 3-hydroxybenzophenone, 4-hydroxybenzophenone, 4,4′-dihydroxybenzophenone, 4,4′-dimethylaminobenzophenone, 4-dimethylaminobenzophenone, 2,5-dimethylbenzophenone, 3,4-dimethylbenzophenone, 2-methylbenzophenone, 3-methylbenzophenone, 4-methylbenzophenone, 4-chloro-benzophenone, 4-phenylbenzophenone, 4,4′-dimethoxybenzophenone, 4-chloro-4′-benzylbenzophenone, 3,3′,4,4′-benzophenonetetra-carboxylic dianhydride; 2-benzyl-2-(dimethylamino)-4′-morpholinobutyrophenone; camphorquinone; 2-chlorothioxanthen-9-one; dibenzosuberenone; benzil; substituted benzils, such as 4,4′-dimethylbenzil; phenanthrene; substituted phenanthrenes, such as phenanthrenequinone; xanthone; substituted xanthones, such as 3-chloroxanthone, 3,9-dichloroxanthone, 3-chloro-8-nonylxanthone; thioxanthone; substituted thioxanthones, such as isopropenylthioxanthone, thioxanthen-9-one; anthraquinone; substituted anthraquinones, such as chloroanthraquinone, 2-ethylanthraquinone, disodium anthraquinone-1,5-disulphonate, sodium anthraquinone-2-sulphonate; benzoin; substituted benzoins, such as benzoin methyl ether, benzoin ethyl ether, benzoin isobutyl ether; 2-naphthalenesulphonyl chloride; methylphenyl glyoxylate; benzaldehyde; cinnamic acid; cumenecyclopentadienyliron(II); hexafluorophosphate; ferrocene. Irgacure® 184 from BASF SE is one example of a commercial photoinitiator.

Peroxides, especially organic peroxides can also be used as crosslinkers V. Examples of organic peroxides are peroxy ketal, for example 1,1-bis(tert-butylperoxy)-3,3,5-trimethyl-cyclohexane, 2,2-bis(tert-butylperoxy)butane; acyl peroxides, for example acetyl peroxide, isobutyl peroxide, benzoyl peroxide, di(4-methylbenzoyl) peroxide, bis(2,4-dichlorobenzoyl) peroxide; dialkyl peroxides, for example di-tert-butyl peroxide, tert-butyl cumyl peroxide, dicumyl peroxide, 2,5-dimethyl-2,5-di(tert-butylperoxy)hexane; and peresters, such as tert-butylperoxy isopropyl carbonate.

Useful crosslinkers V further include azo compounds, for example azobisisobutyronitrile.

When SiH-organosilicon compounds are used, the presence of a hydrosilylation catalyst is necessary. The hydrosilylation catalyst used can be any known catalyst which catalyzes the hydrosilylation reactions taking place in the course of the crosslinking of addition-crosslinking silicone compositions. Useful hydrosilylation catalysts are in particular metals and their compounds from the group consisting of platinum, rhodium, palladium, ruthenium and iridium.

The use of platinum and platinum compounds is preferred. Particular preference is given to platinum compounds which are soluble in polyorganosiloxanes. Soluble platinum compounds used can be, for example, the platinum-olefin complexes of the formulae (PtCl₂.olefin)₂ and H(PtCl₃.olefin), in which case alkenes having 2 to 8 carbon atoms, such as ethylene, propylene, isomers of butene and octene, or cycloalkenes having to 7 carbon atoms, such as cyclopentene, cyclohexene and cycloheptene, are preferably used. Soluble platinum catalysts further include the platinum-cyclopropane complex of the formula (PtCl₂C₃H₆)₂, the reaction products of hexachloroplatinic acid with alcohols, ethers and aldehydes, or mixtures thereof, or the reaction product of hexachloroplatinic acid with methylvinylcyclotetrasiloxane in the presence of sodium bicarbonate in ethanolic solution. Complexes of platinum with vinylsiloxanes, such as sym-divinyltetramethyldisiloxane, are particularly preferred.

It is also possible to use irradiation-activated hydrosilylation catalysts, as described in WO2009/092762 for example.

Hydrosilylation catalyst can be used in any desired form including, for example, in the form of microcapsules containing hydrosilylation catalyst, or polyorganosiloxane particles.

The level of hydrosilylation catalysts is preferably chosen such that the silicone composition SZ has a Pt content of 0.1 to 250 weight ppm, especially of 0.5 to 180 weight ppm.

In the presence of hydrosilylation catalysts the use of inhibitors is preferred. Examples of customary inhibitors are acetylenic alcohols, such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes, for example 1,3,5,7-tetravinyltetramethyltetracyclosiloxane, low molecular weight silicone oils containing (CH₃)(CHR═CH)SiO_{2/2} groups and optionally R₂(CHR═CH)SiO_{1/2} end groups, for example divinyltetramethyldisiloxane, tetravinyldimethyldisiloxane, trialkyl cyanurates, alkyl maleates, for example diallyl maleates, dimethyl maleate and diethyl maleate, alkyl fumarates, for example diallyl fumarate and diethyl fumarate, organic hydroperoxides, for example cumene hydroperoxide, tert-butyl hydroperoxide and pinane hydroperoxide, organic peroxides, organic sulphoxides, organic amines, diamines and amides, phosphanes and phosphites, nitriles, triazoles, diaziridines and oximes. The effect of these inhibitors depends on their chemical structure, so the suitable inhibitor and the level thereof in the silicone composition SZ has to be determined individually.

The inhibitor content of silicone composition SZ is preferably in the range from 0 to 50 000 weight ppm, more preferably in the range from 20 to 2000 weight ppm and especially in the range from 100 to 1000 weight ppm.

When photoinitiators, peroxides or azo compounds are used as crosslinkers V, no catalyst and inhibitor is necessary. When photoinitiators and/or photosensitizers are used for crosslinking, they are used in amounts of 0.1-10% by weight, preferably 0.5-5% by weight and more preferably 1-4% by weight, based on silicone elastomer S1.

When azo compounds or peroxides are used for crosslinking, they are used in amounts of 0.1-10% by weight, preferably 0.5-5% by weight and more preferably 1-4% by weight, based on silicone elastomer S1.

In one preferred embodiment, silicone composition SZ, in addition to alkenyl-containing thermoplastic silicone elastomer S1, also contains alkenyl-containing silicone compound S2. The silicone compound S2 content of silicone composition SZ is preferably not more than 100 parts by weight, more preferably not more than 50 parts by weight and especially not more than parts by weight per 100 parts by weight of silicone elastomer S1.

The alkenyl-containing silicone compound S2 preferably has a composition of average general formula (V)

R¹ₐR²_{b}SiO_{(4-a-b)/2} (V),

where
R¹ represents a monovalent, optionally halogen- or cyano-substituted C₁-C₁₀ hydrocarbon radical which contains aliphatic carbon-carbon multiple bonds and is optionally attached to silicon via an organic divalent group,
R² represents a monovalent, optionally halogen- or cyano-substituted C₁-C₁₀ hydrocarbon radical which is free of aliphatic carbon-carbon multiple bonds and is attached via SiC,
a represents such a non-negative number that every molecule contains not less than two R¹ radicals, and
b represents a non-negative number such that (a+b) lies in the range from 0.01 to 2.5.

The alkenyl groups R¹ are obtainable in an addition reaction with an SiH-functional crosslinker V. Alkenyl groups used typically have from 2 to 6 carbon atoms, such as vinyl, allyl, methallyl, 1-propenyl, 5-hexenyl, ethynyl, butadienyl, hexadienyl, cyclopentenyl, cyclopentadienyl, cyclohexenyl, preferably vinyl and allyl.

Organic divalent groups via which the alkenyl groups R¹ can be attached to polymer chain silicon consist of, for example, oxyalkylene units, such as those of general formula (VI)

—(O)_{c}[(CH₂)_{d}O]ₑ— (VI),

where
c is 0 or 1, especially 0,
d is from 1 to 4, especially 1 or 2, and
e is from 1 to 20, especially from 1 to 5.

The oxyalkylene units of general formula (VI) are attached to a silicon atom on the left-hand side.

The radicals R¹ can be attached in every position of the polymer chain, especially to the terminal silicon atoms.

Examples of unsubstituted radicals R² are alkyl radicals, such as methyl, ethyl, n-propyl, isopropyl, n-butyl, isobutyl, tert-butyl, n-pentyl, isopentyl, neopentyl, tert-pentyl, hexyl, such as n-hexyl, heptyl, such as n-heptyl, octyl, such as n-octyl and isooctyl, such as 2,2,4-trimethylpentyl, nonyl, such as n-nonyl, decyl, such as n-decyl; alkenyl, such as vinyl, allyl, n-5-hexenyl, 4-vinylcyclohexyl and 3-norbornenyl; cycloalkyl, such as cyclopentyl, cyclohexyl, 4-ethylcyclohexyl, cycloheptyl, norbornyl and methylcyclohexyl; aryl, such as phenyl, biphenylyl, naphthyl; alkaryl, such as o-, m-, p-tolyl and ethylphenyl; and aralkyl, such as benzyl, alpha-phenylethyl and β-phenylethyl.

Examples of substituted hydrocarbon radicals R² are halogenated hydrocarbons, such as chloromethyl, 3-chloropropyl, 3-bromo-propyl, 3,3,3-trifluoropropyl and 5,5,5,4,4,3,3-heptafluoro-pentyl, and also chlorophenyl, dichlorophenyl and trifluoro-tolyl.

R² preferably has from 1 to 6 carbon atoms. Methyl and phenyl are particularly preferred.

Silicone compound S2 can also be a mixture of various alkenyl-containing polyorganosiloxanes which differ in the alkenyl group content, in the nature of the alkenyl group or structurally for example.

The structure of silicone compound S2 can be linear, cyclic or else branched. The level of tri- and/or tetrafunctional units leading to branched polyorganosiloxanes is typically very low, preferably not more than 20 mol % and especially not more than 0.1 mol %.

Silicone compound S2 can be a silicone resin. In this case (a+b) is preferably in the range from 2.1 to 2.5 and especially in the range from 2.2 to 2.4.

It is particularly preferable for silicone compound S2 comprises organopolysiloxane resins S2 which consist of R⁴³SiO_{1/2} (M) and SiO_{4/2} (Q) units to an extent of not less than 90 mol %, where R⁴ has the meanings of R¹ or R² subject to the proviso that two or more, especially three or more of R⁴ per molecule represent R¹. These resins are also known as MQ resins. The molar ratio of M to Q units is preferably in the range from 0.5 to 2.0 and more preferably in the range from 0.6 to 1.0. These silicone resins may also contain up to 10% by weight of free hydroxyl or alkoxy groups.

Preferably, these organopolysiloxane resins S2 have a viscosity above 1000 mPas at 25° C. or are solids. The weight-average molecular weight determined using gel permeation chromatography (versus a polystyrene standard) of these resins is preferably at least 200 and more preferably at least 1000 g/mol and preferably at most 200 000 and more preferably at most 20 000 g/mol.

Silicone compound S2 can be a silica surface coated with alkenyl groups R¹. In this case (a+b) is preferably in the range from 0.01 to 0.3 and especially in the range from 0.05 to 0.2. The silica is preferably precipitated silica, especially pyrogenic silica. The silica preferably has an average primary corpuscle particle size less than 100 nm, especially an average primary corpuscle particle size of 5 to 50 nm, although these primary corpuscles usually do not exist in isolation in the silica, but are constituent parts of larger aggregates (as defined in German standard specification DIN 53206) which have a diameter of 100 to 1000 nm.

The silica further has a specific surface area of 10 to 400 m²/g (measured by the BET method in accordance with DIN 66131 and 66132), while the silica has a fractal mass dimension Dm of not more than 2.8, preferably not more than 2.7 and more preferably in the range from 2.4 to 2.6, and a surface silanol group SiOH density of less than 1.5 SiOH/nm², preferably less than 0.5 SiOH/nm² and more preferably of less than 0.25 SiOH/nm².

The carbon content of the silica due particularly to the surface being occupied with alkenyl groups R¹ is preferably in the range from 0.1% to 10% by weight and especially in the range from 0.3 to 5% by weight.

Particular preference for use as silicone compound S2 is given to vinyl-containing polydimethylsiloxanes whose molecules conform to general formula (VII)

(ViMe₂SiO_{1/2})₂(ViMeSiO)ₚ(Me₂SiO)_{q} (VII),

where the non-negative integers p and q satisfy the following relations: p≧0, 50<(p+q)<20 000, preferably 100<(p+q)<1000, and 0<(p+1)/(p+q)<0.2. More particularly, p is =0.

The viscosity of silicone compound S2 of general formula (V) at 25° C. is preferably in the range from 0.5 to 500 Pa·s, especially in the range from 1 to 100 Pa·s and most preferably in the range from 1 to 50 Pa·s.

An example is q=120 and p=0 or q=150 and p=0.

If the silicone composition SZ is an alkenyl-containing silicone compound S2, the proportion of S2 is 0.5-40% by weight, more preferably 2-30% by weight based on SZ.

Silicone composition SZ may contain at least one filler F as additive A. Non-reinforcing fillers F having a BET surface area of up to 50 m²/g include, for example, quartz, diatomaceous earth, calcium silicate, zirconium silicate, zeolites, metal oxide powders, such as aluminum oxide, titanium oxide, iron oxide or zinc oxide and/or mixed oxides thereof, barium sulphate, calcium carbonate, gypsum, silicon nitride, silicon carbide, boron nitride, glass powder and plastics powder. A list of further fillers in particle form can be found in EP 1940940. Reinforcing fillers, i.e. fillers having a BET surface area of not less than 50 m²/g and especially in the range from 100 to 400 m²/g, include, for example, pyrogenic silica, precipitated silica, aluminum hydroxide, carbon black, such as furnace black and acetylene black, and silicon-aluminum mixed oxides of large BET surface area.

Said fillers F can be in a hydrophobicized state, for example due to treatment with organosilanes, organosilazanes and/or organosiloxanes, or due to etherification of hydroxyl groups into alkoxy groups. One type of filler F can be used; a mixture of two or more fillers F can also be used.

The filler content F of silicone composition SZ is preferably not less than 3% by weight, more preferably not less than 5% by weight and especially not less than 10% by weight and not more than 40% by weight.

The silicone composition SZ may as a matter of choice include possible additives as a further constituent A at from 0% to 70% by weight and preferably from 0.0001% to 40% by weight. These ingredients may be, for example, resin-type polyorganosiloxanes other than said alkenyl-containing silicone compound S2 and SiH-organosilicon compound, adhesion promoters, pigments, dyes, plasticizers, organic polymers, heat stabilizers, inhibitors, fungicides or bactericides, such as methylisothiazolones or benzisothiazolones, crosslinking assistants, such as triallyl isocyanurate, flow control agents, surface-active substances, adhesion promoters, photoprotectants such as UV absorbers and/or free-radical scavengers, thixotropic agents.

Solvent L1 is easier than solvent L2 to remove from the solution or suspension prepared in the first step from silicone composition SZ. Easier removal relates particularly to easier evaporation or extraction.

The term solvent L1 comprehends all organic and inorganic compounds which dissolve silicone composition SZ at most temperatures. This term preferably comprehends all compounds which under otherwise identical conditions, for example pressure and temperature, are capable of dissolving silicone composition SZ to a higher degree than solvent L2 is.

That is, the maximum concentration of silicone composition SZ attainable in solvent L1 is preferably higher than the maximum concentration of silicone composition SZ attainable in solvent L2.

This maximum attainable concentration of silicone composition SZ is preferably 2 times, more preferably 5 times, even more preferably 10 times and especially 100 times higher in solvent L1 than in solvent L2. The maximum attainable concentration of silicone composition SZ preferably relates to 20° C. and 1 bar.

The term solvent L1 additionally also comprehends comparatively high molecular weight compounds, for example liquid polymers.

Elevated pressures can also contribute to the solubility, depending on the solvent L1 and silicone composition SZ. Preference is given to solvents L1 in which the silicone-containing polymers dissolve at 20° C. and 1 bar to an extent of not less than 10% by weight, more preferably not less than 15% by weight and especially not less than 20% by weight.

Elevated pressures can also contribute to low solubility, depending on the solvent and the polymer.

The term solvent L2 additionally also comprehends comparatively high molecular weight compounds, for example liquid polymers.

Preference is given to solvents L2 in which silicone composition SZ dissolves at 20° C. and 1 bar to an extent of not more than 20% by weight, more preferably not more than 10% by weight and especially not more than 1% by weight.

Solvent L1 and solvent L2 can each consist of one or more constituents.

Preferably, the vapor pressure of solvent L1 and of all constituents of solvent L1 at 20° C. and 1 bar is higher than that of solvent L2 and all constituents of solvent L2, respectively.

The boiling point of solvent L1 and of all constituents of solvent L1 at 1 bar is preferably not less than 30°, more preferably not less than 40° and especially not less than 50° lower than that of solvent L2 and of all constituents of solvent L2, respectively.

When a suspension of silicone composition SZ in a mixture of solvent L1 and solvent L2 is formed in the first step, this is indicative of an incipient phase separation, which can be partly stopped by stirring.

Transitioning the solution or suspension into the silicone molding can be effected in various ways. In the case of a homogeneous solution of silicone composition SZ, for example, the phase separation in the third step can first give rise to a suspension which in turn then gives rise to an initial gel-body which, by the continued removal of solvent L1/solvent L2, can be converted into a stable membrane M comprising silicone composition SZ.

In the case where a suspension is already present in the first step, the gel structure can be formed from the suspension of silicone composition SZ in the phase separation of the third step. This is quicker in most cases than when starting with homogeneous solutions of silicone composition SZ.

The amount of solvent L1 present in phases A and B after the third step is preferably not more than 30% by weight, more preferably not more than 20% by weight and especially not more than 10% by weight of the amount of solvent L1 used in the first step.

Solvent L1 can be removed from the casting solution in the third step in any technically known way. Solvent L1 is preferably removed by evaporation or extraction.

Examples of preferred technical processes are evaporation by convection, forced convection, heating or evaporation in a moist atmosphere and/or extraction by solvent exchange or washing off with a volatile solvent.

The choice of method has to ensure production of the membrane within an acceptable time, albeit sufficiently long for the structure to actually form.

The choice for the rate of evaporation is preferably such that the liquid-liquid phase separation does not occur under thermodynamic equilibrium conditions, or no porous structures will be produced.

Solvent L2 need not always be inert. Optionally, silicone composition SZ is swellable in solvent L2. The adsorption of preferred solvents L2 in respect of silicone composition SZ is preferably not less than 10% by weight and more preferably not less than 50% by weight.

Apt choice of solvent L2 is important because this decides whether the structure does or does not survive after phase separation.

Solvent L2 can be removed from the membrane in the fourth step in any manner known to a person skilled in the art. Examples are extraction, evaporation, gradual solvent exchange or simply washing solvent L2 off.

The solution or suspension of silicone composition SZ is obtainable in various ways. A preferred embodiment of the invention comprises dissolving silicone composition SZ in solvent L1 and adding solvent L2. In a particularly preferred embodiment of the invention, silicone composition SZ is dissolved in a solvent mixture of L1 and L2.

The solubilities of silicone composition SZ in solvent L1 are familiar to a person skilled in the art or, if no data are available, are easily determined by solubility tests.

The right solvent L2 for this is quickly determined in a few tests, for example in simple turbidity titrations. A solution of silicone composition SZ is admixed with a second solvent until silicone composition SZ is observed to separate out.

Since the solubilities of silicone composition SZ vary substantially, solvents L1 for a particular silicone composition SZ can also be solvents L2 for another silicone composition SZ.

Preferred organic solvents L1/solvents L2 are hydrocarbons, halogenated hydrocarbons, ethers, alcohols, aldehydes, ketones, acids, anhydrides, esters, N-containing solvents and S-containing solvents.

Examples of commonly used hydrocarbons are pentane, hexane, dimethylbutane, heptane, 1-hexene, 1,5-hexadiene, cyclohexane, terpentine, benzene, isopropylbenzene, xylene, toluene, solvent naphtha, naphthalene and also tetrahydronaphthalene. Examples of commonly used halogenated hydrocarbons are fluoroform, perfluoroheptane, methylene chloride, chloroform, carbon tetrachloride, 1,2-dichloroethane, 1,1,1-trichloroethane, tetrachloroethene, trichloroethene, pentyl chloride, bromoform, 1,2-dibromoethane, methylene iodide, fluorobenzene, chlorobenzene and also 1,2-dichlorobenzene. Examples of commonly used ethers are diethyl ether, butyl ethyl ether, anisole, diphenyl ether, ethylene oxide, tetrahydrofuran, furan, triethylene glycol and also 1,4-dioxane. Examples of commonly used alcohols are methanol, ethanol, propanol, butanol, octanol, cyclohexanol, benzyl alcohol, ethylene glycol, ethylene glycol monomethyl ether, propylene glycol, butylglycol, glycerol, phenol and also m-cresol. Examples of commonly used aldehydes are acetaldehyde and butyraldehyde. Examples of commonly used ketones are acetone, diisobutyl ketone, 2-butanone, cyclohexanone and also acetophenone. Commonly used examples of acids are formic acid and acetic acid. Commonly used examples of anhydrides are acetic anhydride and maleic anhydride. Commonly used examples of esters are methyl acetate, ethyl acetate, butyl acetate, phenyl acetate, glycerol triacetate, diethyl oxalate, dioctyl sebacate, methyl benzoate, dibutyl phthalate, DBE® (DuPont de Nemours) and also tricresyl phosphate. Commonly used examples of nitrogenous solvents are nitromethane, nitrobenzene, butyronitrile, acetonitrile, benzonitrile, malononitrile, hexylamine, aminoethanol, N,N-diethylaminoethanol, aniline, pyridine, N,N-dimethylaniline, N,N-dimethylformamide, N-methylpiperazine and also 3-hydroxypropionitrile. Commonly used examples of sulphur-containing solvents are carbon sulphide, methanethiol, dimethyl sulphone, dimethyl sulphoxide and also thiophene.

Commonly used examples of inorganic solvents are water, ammonia, hydrazine, sulphur dioxide, silicon tetrachloride and titanium tetrachloride.

Any non-reactive polymers can be used as comparatively high molecular weight solvents L1/solvents L2. Non-reactive polymers which are liquid at the processing temperature and are available in industrial quantities are used for preference.

Examples of this type of solvents L1/solvents L2 include inter alia polydimethylsiloxanes having non-reactive end groups, for example linear silicones bearing trimethylsily end groups, phenylsiloxanes, cyclic siloxanes, e.g. cyclohexadimethyl-siloxane or cyclodecadimethylsiloxane. Examples of this type of solvent L1/solvent L2 further include polypropylene oxides, polyethylene oxides, polyamides, polyvinyl acetates, polyisobutenes, polyacrylates, polybutadienes, polyisoprenes and copolymers of the listed groups of materials.

Particularly preferred solvents L1 for the thermoplastic silicone elastomers S1 in silicone composition SZ are alcohols, for example isopropanol, or ethers, especially THF. Particularly preferred solvents L1 for silicone compound S2 in silicone composition SZ are, for example, toluene, xylene, benzines (boiling point above 80° C.), pentane, hexane, THF or isopropanol.

Particularly preferred solvents L2 for silicone composition SZ are, for example, ethylene glycol, diethylene glycol, triethylene glycol, tetraethylene glycol, propylene glycol, dipropylene glycol, ethylene glycol dimethyl ether, monomethyl diethylene glycol, dimethyl diethylene glycol, monomethyl triethylene glycol, dimethyl triethylene glycol, diethylene glycol butyl ether, polyethylene glycol, polypropylene glycol, low molecular weight polyglycols such as polyethylene glycol 200, polyethylene glycol 400, polypropylene glycol 425 and polypropylene glycol 725, polyethylene glycol monomethyl ether, polyethylene glycol dimethyl ether, DBE®, glycerol, NMP or DMSO.

Silicone composition SZ can likewise be dissolved in ternary solvent mixtures. A commonly used example of a tertiary solvent mixture can be for instance a mixture of one solvent L1 and two solvents L2.

One example of a ternary solvent mixture consists of isopropanol (solvent L1), N-methylpiperazine (solvent L2) and dimethylformamide (solvent L2). Silicone composition SZ can likewise be dissolved in solvent mixtures comprising more than one solvent L1 and more than two solvents L2.

The mixing ratios between solvent L1 and solvent L2 can vary within wide limits. Preferably, at least 2 and especially at least 10 parts by weight of solvent L2 and at most 5000 and especially at most 1000 parts by weight of solvent L2 are used per 100 parts by weight of solvent L1 in the first step.

The solution or suspension prepared in the first step preferably contains up to 95% by weight, more preferably up to 80% by weight and even more preferably up to 60% by weight of solvent L1 and solvent L2.

Preferably, the solution or suspension prepared in the first step contains not less than 1% by weight, more preferably not less than 10% by weight and especially not less than 15% by weight and not more than 70% by weight, more preferably not more than 40% by weight and especially not more than 25% by weight of silicone composition SZ.

Preferably, the solution or suspension of silicone composition SZ is introduced into a mold in the second step at temperatures of not less than 0° C., more preferably not less than 10° C., especially not less than 20° C. and not more than 60° C. and more preferably not more than 50° C.

In one embodiment of the invention, further additives A are incorporated in the solution or suspension in the first and/or second step. Inorganic salts and polymers are typical additives. Commonly used inorganic salts are LiF, NaF, KF, LiCl, NaCl, KCl, MgCl₂, CaCl₂, ZnCl₂ and CdCl₂. Typical additives A further include suitable emulsifiers which are incorporated in the solution or suspension, for example polydimethylsiloxanes having polyetheroxy, such as ethyleneoxy or propyleneoxy, alkoxy and ammonium groups.

The incorporated additives A can remain in the membrane after it has been formed or be extracted, or washed off with other solvents, after the third, fourth or fifth step.

Mixtures of different additives A can also be incorporated in the solution or suspension. The concentration of additives A in the polymer solution is preferably not less than 0.01% by weight, more preferably not less than 0.1% by weight, especially not less than 1% by weight and not more than 15% by weight, more preferably not more than 10% by weight.

Thus, in a particularly preferred embodiment of the invention, from 1% to 3% by weight of LiCl and from 2% to 5% by weight of NaCl are added to the solution or suspension. In a further particularly preferred embodiment, from 0.5% to 10% by weight of silicone oligomers laterally and/or terminally modified by polyether chains are incorporated in the solution or suspension as additives A.

The solutions or suspensions may further include the additives and ingredients customary in formulations. These include inter alia flow control agents, surface-active substances, adhesion promoters, photoprotectants such as UV absorbers and/or free-radical scavengers, thixotropic agents and also further solid and filler materials. Additions of this type are preferred for producing the particular property profiles desired for the membranes.

Preferred geometric embodiments of obtainable thin porous membranes are foils, hoses, fibers, hollow fibers, mats, the geometric shape not being tied to any fixed forms, but being very largely dependent on the substrates used.

To produce the membranes, the solutions or suspensions of silicone composition SZ are preferably applied to a substrate in the second step. The solutions or suspensions applied to substrates are preferably further processed into foils.

The substrates preferably contain one or more materials from the group comprising metals, metal oxides, polymers or glass. The substrates are in principle not tied to any geometric shape. However, it is preferable to use substrates in the form of plates, foils, textile sheet substrates, woven or preferably nonwoven meshes or more preferably in the form of nonwoven webs.

Substrates based on polymers contain for example polyamides, polyimides, polyetherimides, polycarbonates, polybenzimidazoles, polyethersulphones, polyesters, polysulphones, polytetrafluoroethylenes, polyurethanes, polyvinyl chlorides, cellulose acetates, polyvinylidene fluorides, polyether glycols, polyethylene terephthalate (PET), polyaryletherketones, polyacrylonitrile, polymethyl methacrylates, polyphenylene oxides, polycarbonates, polyethylenes or polypropylenes. Preference is given to polymers having a glass transition temperature Tg of at least 80° C. Substrates based on glass contain for example quartz glass, lead glass, float glass or lime-soda glass.

Preferred mesh or web substrates contain glass, carbon, aramid, polyamide, polyester, polyethylene, polypropylene, polyethylene/polypropylene copolymer or polyethylene terephthalate fibers.

The layer thickness of substrates is preferably ≧1 μm, more preferably ≧50 μm and even more preferably ≧100 μm and preferably ≦2 mm, more preferably ≦600 μm and even more preferably ≦400 μm. The most preferred ranges for the layer thickness of substrates are the ranges formulatable from the aforementioned values.

The thickness of porous membranes comprising silicone composition SZ is chiefly determined by the amount of solution or suspension. Since an evaporation or extraction step is preferred in the process of the present invention, comparatively thin membranes are preferred.

Any technically known form of applying the solution or suspension of silicone composition SZ to substrates can be employed to produce the porous membranes.

The solution or suspension is preferably applied to the substrate using a blade or via meniscus coating, casting, spraying, dipping, screen printing, intaglio printing, transfer coating, gravure coating or spin-on-disk. The solution or suspensions thus applied have film thicknesses of preferably ≧10 μm, more preferably ≧80 μm and preferably ≦10 000 μm, more preferably ≦5000 μm, especially ≦1000 μm. The most preferred ranges for the film thicknesses are the ranges formulatable from the aforementioned values.

It is preferable to use evaporation to remove solvent L1 in the third step from the molded solutions or suspensions and preferably thereafter, in the fourth step, solvent L2 and residues of solvent L1.

The evaporation temperature is preferably not less than 10° C. and more preferably not less than 20° C. and not more than 100° C., more preferably not more than 70° C.

Evaporation can be carried out at any desired pressures, for example at atmospheric pressure, at superatmospheric pressure or at subatmospheric pressure. Evaporation can likewise take place under defined humidity conditions. Depending on the temperature, relative humidities ranging from 0.5 to 99% are particularly preferred.

As mentioned, the evaporation step can also take place under defined solvent atmospheres, for example H₂O vapor, alcohol vapor. The saturation content of the atmosphere can be varied within wide limits, for example between 0% (dry atmosphere) to 100% (complete saturation at the process temperature). This makes it possible to vary the evaporation rate of solvent L1 and/or the imbibition of a solvent L1/solvent L2 from the atmosphere within wide limits.

The preferred duration of evaporation for any one system can be determined in a few tests. Evaporation preferably takes at least 0.1 seconds to several hours.

An exact evaporation time cannot be specified, since it has to be determined separately for each system and for each solution or suspension.

Evaporation time as well as evaporation conditions have an influence on the porous structures with regard to pore type, pore size and overall porosity.

In a likewise preferred embodiment of the invention, solvent L2 and residues of solvent L1 are removed in the fourth step by extraction.

This extraction is preferably done with a further solvent which does not destroy the porous structure formed, but is readily miscible with solvent L2. It is particularly preferable to use water as extractant. Extraction preferably takes place at temperatures between 20° C. and 100° C. The preferred extraction time can be determined in a few tests for the particular system. The extraction time is preferably at least 1 second to several hours. And the operation can also be repeated more than once.

The fourth step comprises a) removing solvent L2 and residues of solvent L1 and b) subjecting silicone composition SZ to a crosslinking reaction. The order in which this is done is freely choosable in that the two subsidiary steps a) and b) can be carried out in succession or concurrently. It is preferably first a) the removal of solvent L2 and residues of solvent L1 and then b) the crosslinking of silicone composition SZ. When silicone composition SZ is crosslinked using SiH-organosilicon compound and hydrosilylation catalyst, the crosslinking reaction is preferably effected thermally, preferably at 30 to 250° C., more preferably at not less than 50° C., especially at not less than 100° C., preferably at 120-210° C. When UV-switchable hydrosilylation catalysts are used, the crosslinking is effected by irradiating with light of wavelength 230-400 nm for preferably at least 1 second, more preferably at least 5 seconds and preferably at most 500 seconds, more preferably at most 240 seconds.

When silicone composition SZ is crosslinked using photoinitiators, silicone composition SZ is preferably irradiated with light for not less than 1 second, more preferably not less than 5 seconds and preferably not more than 500 seconds, more preferably not more than 240 seconds. Crosslinking with photoinitiators can be carried out under a protective gas such as, for example, N₂ or Ar or under air.

After irradiation with light, irradiated silicone composition SZ is heated, preferably for not more than 1 hour, more preferably for not more than 10 minutes and especially for not more than 1 minute, to cure it.

Crosslinking under UV radiation, especially at 254 nm, is particularly preferred.

When silicone composition SZ is crosslinked using peroxides, crosslinking is preferably effected thermally, preferably at 80 to 300° C. and more preferably at 100-200° C. Thermal crosslinking preferably takes at least 1 minute, more preferably at least 5 minutes and preferably at most 2 hours, more preferably at most 1 hour.

Crosslinking with peroxides can be carried out under a protective gas such as, for example, N₂ or Ar or under air.

When azo compounds are used to crosslink silicone composition SZ, crosslinking is preferably effected thermally, preferably at 80 to 300° C., more preferably at 100-200° C. Thermal crosslinking preferably takes at least 1 minute, more preferably at least 5 minutes and preferably at most 2 hours, more preferably at most 1 hour.

Crosslinking with azo compounds can also be carried out under irradiation with UV light.

Crosslinking with azo compounds can be carried out under a protective gas such as, for example, N₂ or Ar or under air.

The membranes can likewise be crosslinked by irradiating with electron beams.

The crosslinked membranes are notable for the degree of crosslinking being >50%, preferably >70%. The degree of crosslinking is the proportion of polymer which will no longer dissolve in organic solvents that normally dissolve organo-polysiloxane-polyurea copolymers. THF and isopropanol are examples of such solvents. One method to determine the degree of crosslinking is to extract the membrane in isopropanol at 82° C. (1.013 bar (abs.)) for 1 h and then determine the insoluble polymer fraction gravimetrically.

The crosslinked membranes are also notable for their shrinkage in humid atmosphere to be distinctly improved compared with uncrosslinked membranes.

It is preferable to manufacture membranes comprising silicone composition SZ which have a uniform pore distribution along the cross section. It is particularly preferable to produce microporous moldings, having pore sizes of 0.1 μm to 20 μm. The membranes preferably have an isotropic distribution of pores.

The membranes obtained by the process generally have a porous structure. The free volume is preferably at least 5% by volume, more preferably at least 20% by volume and especially at least 35% by volume and at most 90% by volume, more preferably at most 80% by volume and especially at most 75% by volume.

Membrane porosity can be still further enhanced by orienting. The membrane can be drawn monoaxially or biaxially. Orienting preferably takes place prior to crosslinking.

The membranes thus obtained can be directly used, for example, for separation of mixtures. Alternatively, the membranes can also be lifted off the substrate and then be used directly without further support or, optionally, applied to other substrates, such as wovens, nonwovens or foils, preferably at elevated temperatures and by employment of pressure, for example in a hot press or in a laminator. As adhesive materials there may be used, for example, adhesives based on silicone, acrylate, epoxide, poly(urethane) or poly(olefin). Adhesion promoters, for example silanes, can optionally be used to further improve the adherence of the membranes to the support structures.

The composite material is also obtainable by fusing the membrane to the support structure.

In a further preferred form of the invention, the porous membranes are produced by extrusion into self-supporting foils or onto substrates, particularly after the fourth step.

The finalized membranes have layer thicknesses of preferably at least 1 μm, more preferably at least 10 μm, especially at least 15 μm and preferably at most 10 000 μm, more preferably at most 2000 μm, especially at most 1000 μm and even more preferably at most 500 μm.

The surfaces of the membranes can be in a coated state. The surface coating or the impregnated surface of the membranes preferably has a thickness of not less than 10 nm, more preferably not less than 100 nm, especially not less than 500 nm and preferably not more than 500 μm, more preferably not more than 50 μm, especially not more than 10 μm. Suitable coating materials include, for example, polymers such as polyamides, polyimides, polyetherimides, polyethers, polycarbonates, polybenzimidazoles, polyethersulphones, polyesters, polysulphones, polytetrafluoroethylenes, polyurethanes, silicones, polydimethylsilicones, polymethyl-phenylsilicones, polymethyloctylsilicones, polymethylalkyl-silicones, polymethylarylsilicones, polyvinyl chlorides, polyether glycols, polyethylene terephthalate (PET), polyaryletherketones, polyacrylonitrile, polymethyl methacrylates, polyphenylene oxides, polycarbonates, polyethylenes or polypropylenes. The polymers can be applied to the membrane in a conventional manner, for example by lamination, spraying, blade coating or adhesively. A coating of this type is preferably applied to membranes having pores of nm to 10 μm.

The membranes are useful as a coating for three-dimensional constructs to modify the surface properties thereof with regard to, for example, acoustical or thermal insulation or shock absorption. The breathability achievable with the coating can be a desired additional property. It is preferable for housings, building products or textiles to be coated or laminated with the membranes of the present invention.

The porous membranes comprising silicone composition SZ can further also be used in wound patches. It is likewise preferable to use the porous membranes in packaging materials especially in the packaging of food items which, after production, undergo still further, ripening processes. The membranes of the present invention can preferably likewise be used in apparel items, e.g. jackets, gloves, caps or shoes, or as roof felts. The membranes in these uses are water repellent and breathable.

The membranes are useful for all commonly employed processes for separating mixtures, such as reverse osmosis, gas separation, pervaporation, nanofiltration, ultrafiltration or microfiltration. The membranes can be used to effect solid-solid, gas-gas, solid-gas or liquid-gas, especially liquid-liquid and liquid-solid separation of mixtures.

The membranes can be made up into the commonly used modules, for example into hollow fiber modules, spiral-wound modules, plate modules, cross-flow modules or dead-end modules.

The above symbols in the above formulae all have their respective meanings independently of each other. The silicon atom is tetravalent in all formulae.

In the examples which follow, all amounts and percentages are by weight, all pressures are 1.013 bar (abs.) and all temperatures are 20° C., unless otherwise stated.

### Description of Starting Compounds Used:

MQ resin: MQ resin 804 (0.7 mmol of vinyl groups/g) from Wacker Chemie AG (Germany).
Vinyl polymer: α,ω-divinylpolydimethylsiloxane having a molar mass of 11 300 g/mol from Wacker Chemie AG (Germany).
Photoinitiator: 1-hydroxycyclohexyl phenyl ketone commercially available under the trade name Irgacure® 184 from BASF SE (Germany).
Peroxide: tert-butyl peroxypivalate commercially available as 75% solution in alkanes from United Initators (Germany).
Si—H crosslinker HMS-501: copolymer comprising dimethylsiloxane and hydridomethylsiloxane units and having a molar mass of 900-1200 g/mol and an Si—H content of 50-55 mol % of hydridomethylsiloxane units, commercially available from ABCR GmbH & Co. KG, Germany.
Si—H crosslinkers with terminal Si—H units: α,ω-Si—H-terminated polydimethylsiloxane having a viscosity of 5.5-8 mm²/s (25° C.) and a hydride content of 0.27-0.35% from Wacker Chemie AG (Germany).
Cyclic Si—H crosslinker: mixture of cyclopentahydridomethyl-siloxane and cyclohexahydridomethylsiloxane with a hydride content of 1.7% from Wacker Chemie AG (Germany).
Pt catalyst: KATALYSATOR EP (1,1,3,3-tetramethyl-1,3-divinyldisiloxane-platinum complex), commercially available from Wacker Chemie AG (Germany).
Pt-UV catalyst: a Pt compound as described in Example 12 of WO2009/092762 is used as catalyst.
Inhibitor: 1-ethynyl-1-cyclohexanol, commercially available from Sigma-Aldrich, Germany.

Silicone membranes are produced from the polymer solutions obtained by using a Coatmaster® 509 MC-I knife-orienting device from Erichsen, which is equipped with a chamber-type coating knife with a film width of 11 cm and a gap height of 600 μm.

In the examples which follow, the solubility of the polymer content of the membranes obtained was determined as follows (“solubility test”):

The membrane piece is dried at 100° C., weighed and extracted in isopropanol at 82° C. and 1.013 bar (abs.) for one hour. Uncrosslinked membranes dissolve completely under these conditions. After one hour, the membrane is again dried at 100° C. and then weighed.

### COMPARATIVE EXAMPLE NOT ACCORDING TO THE INVENTION

### Producing an Uncrosslinked Porous Silicone Membrane

A solution consisting of 30.0 g of isopropanol and 6.0 g of an organopolysiloxane-polyurea copolymer (SLM TPSE 100 from Wacker Chemie AG) is admixed with 9.0 g of triethylene glycol. The entire batch is subsequently dissolved on a vertical shaker at room temperature in the course of 1 h to obtain a clear viscous solution having a solids content of 13% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-orienting frame is filled with the solution and drawn over the glass plate at a constant film-orienting speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h.

The membrane obtained is opaque and about 120 μm in thickness and has an average pore size of 4 μm.

The degree of crosslinking as per the above-described solubility test is 0% by weight.

### Example 1

### Producing a Vinyl-Containing Amino-Functional Siloxane

3276 g of bishydroxy-terminated polydimethylsiloxane having one vinyl group per molecule and an average molecular weight of 903 g/mol were reacted at 100° C. with 921 g of N-((3-amino-propyl)dimethylsilyl)-2,2-dimethyl-1-aza-2-silacyclopentane. ¹H NMR and ²⁹Si NMR showed that all OH groups had been converted to aminopropyl units after 3 h. The product was purified by thin-filming; it has a viscosity of 13 mPas (The flow curve was recorded with a plate-cone viscometer using a 1°/40 mm cone, after conditioning to 25° C. Following a pre-shearing period, the shear stress was raised from 1000 mPa to 5000 mPa in 400 mPa increments. The resulting shear rates were measured. The Newtonian approach was applied.).

### Example 2

### Producing a Vinyl-Containing Organopolysiloxane-Polyurea Copolymer

20 g of the vinyl-containing amino-functional siloxane from Example 1, 0.17 g of 2-methylpentamethylenediamine, 2.52 g of 1,3-bis(1-isocyanato-1-methylethyl)benzene and 0.9 g of 4,4′-methylenebis(cyclohexyl isocyanate) are stirred in 170 mL of THF for 3 h at 80° C. until complete conversion of all monomers. A highly viscous mass is obtained. The solvent is removed at 100° C. and 10 mbar to obtain a transparent polymer having an average molar mass of M_{w}=76 000 g/mol and M_{w}/Mₙ=2.2, as measured using GPC (calibrated against polystyrene standard; THF with 0.5% of triethylamine as mobile phase; flow rate 0.7 mL/min; columns: ResiPore &. MesoPore 300×7.5 mm; ELSD detector).

### Example 3

### Producing a Crosslinked Porous Silicone Membrane by UV Irradiation

A solution consisting of 80.0 g of THF and 20.0 g of a vinyl-containing organopolysiloxane-polyurea copolymer from Example 2 is admixed with 30.1 g of triethylene glycol and 0.6 g of Irgacure 184. The entire batch is subsequently dissolved on a vertical shaker at room temperature in the course of 1 h to obtain a clear viscous solution having a solids content of 15% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-orienting frame is filled with the solution and drawn over the glass plate at a constant film-orienting speed of 10 mm/s.

Thereafter, the still liquid wet film is air dried at 20° C. for 4 h, during which the film develops slight cloudiness.

The film is subsequently irradiated with a UV lamp (254 nm wavelength) for 3 min.

The membrane thus obtained, which still contains triethylene glycol, is then subsequently placed in water for 6 h to remove the triethylene glycol. Thereafter, the membrane is air dried for 6 h.

The membrane obtained is opaque and about 100 μm in thickness and has an average pore size of 4 μm.

The degree of crosslinking as per the above-described solubility test is 100% by weight.

### Example 4

### Producing a Crosslinked Porous Silicone Membrane by Hydrosilylation

A solution consisting of 13.3 g of tetrahydrofuran and 3.3 g of vinyl-containing organopolysiloxane-polyurea copolymer from Example 2 is admixed with 5.0 g of triethylene glycol, 0.28 g of Si—H crosslinker HMS-501, and also 170 ppm of Pt catalyst and 0.02 g of ethynylcyclohexane (each based on the organo-polysiloxane-polyurea copolymer). The entire batch is subsequently dissolved on a vertical shaker at room temperature in the course of 1 h to obtain a clear viscous solution having a solids content of 16% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-orienting frame is filled with the solution and drawn across the glass plate at a constant film-orienting speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h and subsequently crosslinked at 150° C. in the course of 5 min.

The membrane obtained is opaque and about 100 μm in thickness and has an average pore size of 4 μm.

The degree of crosslinking as per the above-described solubility test is 84% by weight.

### Example 5

### Producing a Crosslinked Porous Silicone Membrane by Hydrosilylation

A solution consisting of 17.7 g of tetrahydrofuran and 4.5 g of vinyl-containing organopolysiloxane-polyurea copolymer from Example 2 is admixed with 6.7 g of triethylene glycol, 0.22 g of Si—H crosslinker with terminal Si—H units, and also 170 ppm of Pt catalyst (based on the organopolysiloxane-polyurea copolymer) and 0.024 g of ethynylcyclohexane. The entire batch is subsequently dissolved on a vertical shaker at room temperature in the course of 1 h to obtain a clear viscous solution having a solids content of 16% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-orienting frame is filled with the solution and drawn across the glass plate at a constant film-orienting speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h and subsequently crosslinked at 100° C. in the course of 15 min.

The membrane obtained is opaque and about 100 μm in thickness and has an average pore size of 4 μm.

The degree of crosslinking as per the above-described solubility test is 88% by weight.

### Example 6

### Producing a Crosslinked Porous Silicone Membrane by UV-Activated Hydrosilylation

A solution consisting of 84 g of tetrahydrofuran and 20 g of vinyl-containing organopolysiloxane-polyurea copolymer from Example 2 is admixed with 35.0 g of triethylene glycol, 1.6 g of Si—H crosslinker HMS-501, and also 0.3 g of Pt-UV catalyst (corresponds to 60 ppm of Pt based on the organopolysiloxane copolymer). The entire batch is subsequently dissolved on a vertical shaker at room temperature in the course of 1 h to obtain a clear viscous solution having a solids content of 15% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-orienting frame is filled with the solution and drawn across the glass plate at a constant film-orienting speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h. The film is subsequently irradiated in a UV-Cube from Höhnle, Germany, using a wavelength of 230-400 nm on both sides for 0.5 min each.

The membrane obtained is opaque and about 120 μm in thickness and has an average pore size of 3-6 μm.

The degree of crosslinking as per the above-described solubility test is 84% by weight.

### Example 7

### Producing a Crosslinked Porous Silicone Membrane by Peroxide Crosslinking

A solution consisting of 30.0 g of tetrahydrofuran and 6.0 g of a vinyl-containing organopolysiloxane-polyurea copolymer from Example 2 is admixed with 9.0 g of triethylene glycol and 0.24 g of peroxide. The entire batch is subsequently dissolved on a vertical shaker at room temperature in the course of 1 h to obtain a clear viscous solution having a solids content of 13% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-drawing frame is filled with the solution and drawn over the glass plate at a constant film-drawing speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h and then crosslinked at 100° C. for 10 min.

The membrane obtained is opaque and about 130 μm in thickness and has an average pore size of 3 μm.

The degree of crosslinking as per the above-described solubility test is 92% by weight.

### Example 8

### Producing a Porous Silicone Membrane which is Oriented and Crosslinked by Hydrosilylation

A solution consisting of 84 g of tetrahydrofuran and 20 g of a vinyl-containing organopolysiloxane-polyurea copolymer from Example 2 is admixed with 35.0 g of triethylene glycol, 1.6 g of Si—H crosslinker HMS-501 and also 0.3 g of PT-UV catalyst (corresponds to 60 ppm of Pt based on the organopolysiloxane copolymer). The entire batch is subsequently dissolved on a vertical shaker at room temperature in the course of 1 h to obtain a clear viscous solution having a solids content of 15% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-drawing frame is filled with the solution and drawn over the glass plate at a constant film-drawing speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h. The membrane is then biaxially oriented by a factor of two at 80° C. in a water bath. The film is subsequently irradiated with a UV lamp (254 nm wavelength) on both sides for 0.5 min each side. Scanning electron micrographs show that orienting has distinctly enhanced the porosity and reduced the thickness of the pore walls. The degree of crosslinking as per the above-described solubility test is 60% by weight.

### Example 9

### Producing a Crosslinked Porous Silicone Membrane by Hydrosilylation

A solution consisting of 12 g of tetrahydrofuran and 3.04 g of vinyl-containing organopolysiloxane-polyurea copolymer from Example 2 is admixed with 4.5 g of triethylene glycol, 0.27 g of Si—H crosslinker HMS-501, 1.23 g of vinyl polymer as alkenyl-containing silicone compound S2 and also 170 ppm of Pt catalyst and 0.03 g of ethynylcyclohexane (each based on the organopolysiloxane-polyurea copolymer). The entire batch is subsequently dissolved on a vertical shaker at room temperature in the course of 1 h to obtain a clear viscous solution having a solids content of 21% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-drawing frame is filled with the solution and drawn over the glass plate at a constant film-drawing speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h and then crosslinked at 100° C. for 15 min.

The membrane obtained is opaque and about 109 μm in thickness and has an average pore size of 4 μm.

### Example 10

### Producing a Crosslinked Porous Silicone Membrane by Hydrosilylation

A solution consisting of 24 g of tetrahydrofuran and 6.0 g of vinyl-containing organopolysiloxane-polyurea copolymer from Example 2 is admixed with 9 g of triethylene glycol, 0.26 g of cyclic Si—H crosslinker, 0.61 g of vinyl polymer, 0.6 g of MQ resin 804 as alkenyl-containing silicone compound S2 and also 170 ppm of Pt catalyst (based on the organopolysiloxane-polyurea copolymer) and 0.045 g of ethynylcyclohexane. The entire batch is subsequently dissolved on a vertical shaker at room temperature in the course of 1 h to obtain a clear viscous solution having a solids content of 18% by weight.

To produce the membrane, first a glass plate used as substrate is fixed by means of a vacuum suction plate. Prior to knife application, the glass plate is wiped with a cleanroom cloth soaked in ethanol. In this way, any particulate contamination present is removed.

Thereafter, the film-orienting frame is filled with the solution and drawn across the glass plate at a constant film-orienting speed of 10 mm/s.

Thereafter, the still liquid wet film is air dried at 20° C. for 4 h, during which the film develops slight cloudiness.

The membrane thus obtained, which still contains triethylene glycol, is then subsequently placed in water for 6 h to remove the triethylene glycol. Thereafter, the membrane is air dried for 6 h and subsequently crosslinked at 100° C. in the course of 15 min.

The membrane obtained is opaque and about 109 μm in thickness and has an average pore size of 4 μm.

The degree of crosslinking as per the above-described solubility test is 65% by weight.

### Example 11

### Mechanical Investigations of Membranes from Example 4 and the Comparative Example

The tensile tests were carried out in accordance with EN ISO 527-3. To investigate the mechanical properties, 5 rectangular specimens (6 cm*1 cm) were die-cut out of each of the membranes obtained. The specimens thus obtained are pulled apart at a rate of 0.5 cm/s. The stress-strain curves determined are used to determine the modulus of elasticity, the breaking stress and the breaking strain.

| | Modulus of | | |
|---|---|---|---|
| | elasticity | Breaking | Breaking |
| | [N/mm²] | stress [MPa] | strain [%] |
| comparative | 54.43 | 2.49 | 77.86 |
| example | | | |
| Example 4 | 75.62 | 5.41 | 71.55 |

The crosslinked membrane from Example 4 exhibits a distinctly increased modulus of elasticity and breaking stress than the uncrosslinked membrane from the comparative example. Hence the crosslinked membranes are distinctly more stable and robust than the uncrosslinked membranes.

### Example 12

### Testing the Thermal Stability and the Shrinkage of Membranes from Example 3 and the Comparative Example

An 8 cm*7.5 cm piece of the membrane from the comparative example and a 9.5 cm*7 cm piece of the membrane from Example 3 are placed in water at 80° C. and the shrinkage of the two materials is determined by redetermining the dimensions of the membrane pieces after certain time intervals.

| | comparative example | Example 3 shrinkage |
|---|---|---|
| time [h] | shrinkage [%] | [%] |
| 0 | 0.0 | 0.0 |
| 2 | 9.8 | 0.0 |
| 4 | 12.7 | 0.0 |
| 24 | 18.5 | 0.0 |
| 48 | 18.5 | 1.4 |

The crosslinked membrane from Example 3 exhibits significantly less shrinkage than the uncrosslinked membrane from the comparative example.

### Example 13

### Determining the Hydrohead of Membranes from the Comparative Example and Example 4

The hydrohead is determined to DIN 53886 (Testing of Textiles; Determination of Waterproofness, Water Pressure Test). The determination is carried out using an FX 3000 instrument from TEXTEST Instruments.

| Membrane | Breakthrough pressure [mbar] *⁾ |
|---|---|
| comparative example | 280 |
| Example 4 | 620 |

*⁾ pressure at which the first drop of water passes through.

A significantly higher water pressure can be applied to the crosslinked membrane from Example 4 than to the uncrosslinked membrane from the comparative example.

It is clear from the proffered examples that the crosslinked membranes have better performance characteristics than the uncrosslinked membranes.

1. A process for producing thin porous membranes having layer thicknesses from 1 μm to 10,000 μm, and comprising thermoplastic silicone compound S, wherein
a first step comprises forming a solution or suspension from silicone composition SZ which contains alkenyl-containing thermoplastic silicone elastomer S1, alkenyl-containing silicone compound S2 and crosslinker V, in a mixture of solvent L1 and solvent L2, where solvent L1 is easier than solvent L2 to remove from the solution or suspension prepared in the first step from silicone composition SZ and where a maximum concentration of silicone composition SZ attainable in solvent L1 is higher than a maximum concentration of silicone composition SZ attainable in solvent L2,
a second step comprises introducing the solution or suspension into a mold,
a third step comprises removing solvent L1 from the solution or suspension until the solubility of silicone composition SZ in the mixture of solvent L1 and solvent L2 is forfeited to form a phase A, which is rich in silicone composition SZ, and a phase B, which is lean in silicone composition SZ and hence to effect structure formation by said phase A, and
a fourth step comprises removing said solvent L2 and residues of solvent L1, and subjecting the silicone composition SZ to a crosslinking reaction to form silicone compound S,
wherein said thermoplastic silicone elastomer S1 utilizes organopolysiloxane/polyurea/polyurethane/polyamide or polyoxalyldiamine copolymers of general formula (I) 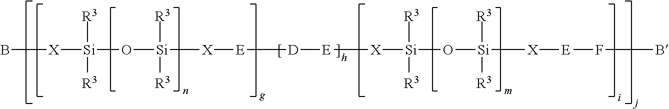
where structural element E is selected from the general formulae (Ia-f) 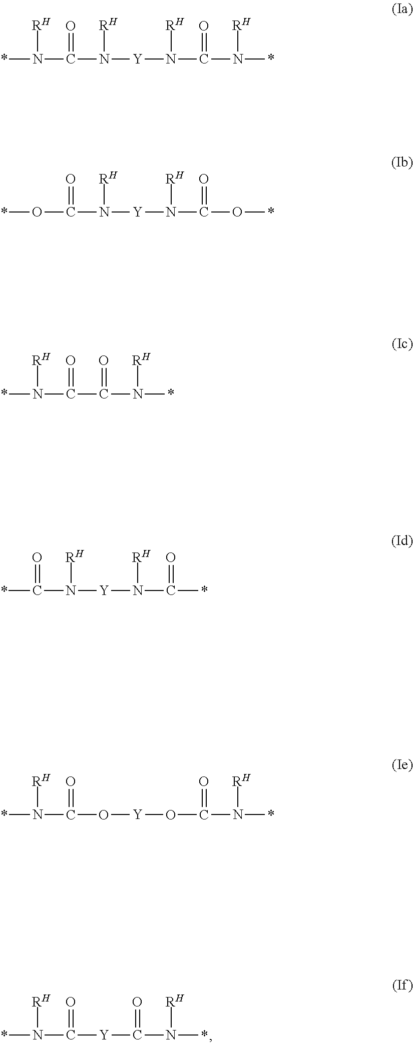
where structural element F is selected from the general formulae (Ia-f) 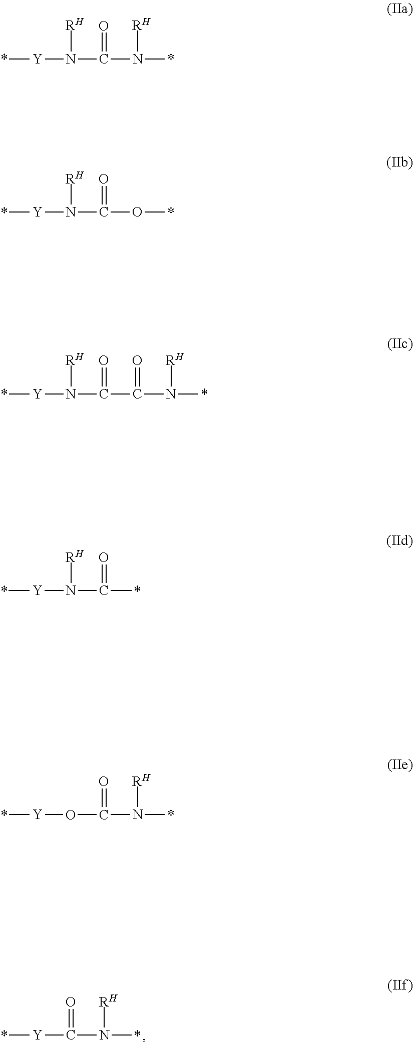
where
R³ represents substituted or unsubstituted hydrocarbon radicals which may be interrupted by oxygen or nitrogen atoms,
R^{H} represents hydrogen or has the meanings of R³,
X represents an alkylene radical of 1 to 20 carbon atoms where mutually non-adjacent methylene units may be replaced by —O— groups, or an arylene radical of 6 to 22 carbon atoms,
Y represents a divalent optionally fluorine- or chlorine-substituted hydrocarbon radical of 1 to 20 carbon atoms,
D represents an alkylene radical of 1 to 700 carbon atoms which is optionally substituted by fluorine, chlorine, C₁-C₆ alkyl or C₁-C₆ alkyl ester and in which mutually non-adjacent methylene units may be replaced by —O—, —COO—, —OCO—, or —OCOO— groups, or an arylene radical of 6 to 22 carbon atoms,
B and B′ each represent a reactive or non-reactive end group attached to the polymer by a covalent bond,
m represents an integer from 1 to 4000,
n represents an integer from 1 to 4000,
g represents an integer of not less than 1,
h represents an integer from 0 to 40,
i represents an integer from 0 to 30, and
j represents an integer above 0,
with the proviso that at least two R³ radicals per molecule contain at least one alkenyl group and where the silicone compound S2 has a composition of average general formula (V)
R¹ₐR²_{b}SiO_{(4-a-b)/2} (V),
where
R¹ represents a monovalent, optionally halogen- or cyano-substituted C₁-C₁₀ hydrocarbon radical which contains aliphatic carbon-carbon multiple bonds and is optionally attached to silicon via an organic divalent group,
R² represents a monovalent, optionally halogen- or cyano-substituted C₁-C₁₀ hydrocarbon radical which is free of aliphatic carbon-carbon multiple bonds and is attached via SiC,
a represents such a non-negative number that every molecule contains not less than two R¹ radicals, and
b represents a non-negative number such that (a+b) lies in a range from 0.01 to 2.5.

2. (canceled)

3. The process according to claim 1, wherein the R³ radicals containing alkenyl groups are alkenyl radicals having 2 to 12 carbon atoms.

4. The process according to claim 1, wherein the crosslinker V is selected from the group consisting of organosilicon compounds containing two or more SiH functions per molecule, peroxides and azo compounds.

5. The process according to claim 4, wherein the organosilicon compound containing two or more SiH functions per molecule has a composition of average general formula (III)
H_{f}R⁵_{g}SiO_{(4-f-g)/2} (III),
where
R⁵ represents a monovalent, optionally halogen- or cyano-substituted C₁-C₁₈ hydrocarbon radical which is free of aliphatic carbon-carbon multiple bonds and is attached via SiC, and
f and g represent non-negative integers,
with the proviso that 0.5<(f+g)<3.0 and 0<f<2, and that each molecule contains at least two silicon-attached hydrogen atoms.

6-7. (canceled)

8. The process according to claim 1, wherein the maximum attainable concentration of silicone composition SZ in solvent L1 is not less than 5 times higher than the maximum attainable concentration of silicone composition SZ in solvent L2.

9. A membrane comprising silicone compound S, which is obtainable by the process of claim 1.

10. The membrane of claim 9, which is configured for separation of mixtures, for use in wound patches, for coating housings, for use in building products, for use as a layer in textiles or for use as a packaging materials.

11. The process according to claim 3, wherein the crosslinker V is selected from the group consisting of organosilicon compounds containing two or more SiH functions per molecule, peroxides and azo compounds.

12. The process according to claim 11, wherein the organosilicon compound containing two or more SiH functions per molecule has a composition of average general formula (III)
H_{f}R⁵_{g}SiO_{(4-f-g)/2} (III),
where
R⁵ represents a monovalent, optionally halogen- or cyano-substituted C₁-C₁₈ hydrocarbon radical which is free of aliphatic carbon-carbon multiple bonds and is attached via SiC, and
f and g represent non-negative integers,
with the proviso that 0.5<(f+g)<3.0 and 0<f<2, and that each molecule contains at least two silicon-attached hydrogen atoms.

13. The process according to claim 12, wherein the maximum attainable concentration of silicone composition SZ in solvent L1 is not less than 5 times higher than the maximum attainable concentration of silicone composition SZ in solvent L2.
